(19) United States
(12) Patent Application Publication
(10) Pub. No.: US 2015/0043852 A1
(43) Pub. Date: Feb. 12, 2015

(54) Rolling Bearing With Reduced Friction Torque

(71) Applicants: Thierry Adane, Tours (FR); Stéphane Cordier, Tours (FR); Yves-André Liverato, Saint Paterne Racan (FR); Pietro Tesini, Gothenburg (SE)

(72) Inventors: Thierry Adane, Tours (FR); Stéphane Cordier, Tours (FR); Yves-André Liverato, Saint Paterne Racan (FR); Pietro Tesini, Gothenburg (SE)

(21) Appl. No.: 14/369,956

(22) PCT Filed: Dec. 28, 2011
(86) PCT No.: PCT/EP2011/074137

§ 371 Date: Oct. 29, 2014

(51) Int. Cl. F16C 33/66; F16C 33/64; F16C 33/60

(52) U.S. Cl. CPC F16C 33/66; F16C 33/60; F16C 33/64
USPC 384/473; 384/499

(57) ABSTRACT

A rolling bearing comprising an inner ring, an outer ring, at least one row of rolling elements between a pair of raceways, each raceway provided on the respective inner ring and outer ring, and an annular housing comprising at least one part surrounding at least one of the rings. The outer ring comprises two separate parts. Each of the two parts of the outer ring defines one closed space with the housing. The ratio between the radius of one raceway and the diameter of the rolling elements is higher than 0:55.

### CROSS-REFERENCE TO RELATED APPLICATIONS

This is a National Stage application claiming the benefit of International Application Number PCT/EP2011/074137 filed on 28 Dec. 2011, which is incorporated herein by reference in its entirety. It is noted that 28 Jun. 2014 falls on a Saturday, and therefore, the instant application is considered co-pending through the next business day, 30 Jun. 2014.

### FIELD OF THE INVENTION

The present invention relates to rolling bearings, in particular to rolling bearings comprising an inner ring and an outer ring with one or more rows of rolling elements held by a cage between raceways provided on the two rings.

### SUMMARY OF THE INVENTION

The rolling elements may, for example, be balls. The rolling bearings may be, for example, those used in industrial electric motors or in motor vehicle gearboxes. In such applications, any geometry variations in one raceway compared to the other can have a negative effect on the bearing performances, especially on friction torque. Even when the two raceways are similar, the assembly of the rolling bearing can bring on some geometry variations between the raceways. The service life of the rolling bearing is essentially related to the friction torque between the rolling elements and the raceways. Any geometry variations between the raceways generally lead to rapid degradation and failure of the bearing. Friction torque is thus dependent of the design of the raceways.

One aim of the present invention is therefore to overcome the aforementioned drawbacks.

It is a particular object of the present invention to reduce the friction torque between the rolling elements and the raceways in order to increase the service life of the rolling bearing. It is thus a particular object of the invention to maintain a contact point between the rolling elements and the raceways in any circumstances, so that a possible radial offset of the two outer raceways will not have an impact on the friction torque of the bearing.

In one embodiment, a rolling bearing comprises an inner ring, an outer ring, at least one row of rolling elements between raceways of the inner and outer rings, and an annular housing comprising at least one part surrounding at least one of the rings. Said outer ring comprises two separate parts, each of the two parts of said outer ring defining one closed space with the housing.

The ratio between the radius of curvature of one raceway and the diameter of the rolling elements is higher than 0:55.

The use of raceways having such a ratio reduces the friction torque between the rolling elements and the raceways, and thus increases the service life of the bearing

Advantageously, the ratio is comprised between 0:55 and 0:71.

The ratio may be higher than 0:71, for example infinite, so that each part of the outer ring comprises a flat portion contacting said rolling elements so as to form a raceway for said rolling elements.

In case of geometric variations between the two outer raceways, the flat portions forming the outer raceways of the rolling bearing absorb these variations and do not have any influence on the friction torque. The use of flat raceways on the two outer half rings makes the raceways more flexible, which reduces the wear of the bearing when operating.

Advantageously, the angle between the flat portion and the rotation symmetry axis of the bearings is comprised between 25° and 45°. Each part of the outer ring further comprises an outer cylindrical portion, a radial portion and an inner cylindrical portion. Said flat portion is connected to the radial portion and the inner axial cylindrical portion.

For example, the angle may be comprised between 40° and 50°, and more preferably equal to 45°.

The parts of the outer ring can be manufactured by cutting and pressing a metal sheet.

The housing can comprise two distinct parts for retaining the parts of said outer ring and fixing means for fixing the distinct parts together, said first part of the housing comprising an axial cylindrical inner portion for retaining radially said outer rings and said second part of the housing comprising an axial cylindrical outer portion surrounding said axial cylindrical inner portion.

For example, the first part of the housing comprises a radial flange extending radially from the cylindrical inner portion towards the inner ring and defining with one of the parts of the outer ring a first closed space and the second part of the housing comprises a radial flange extending radially from the cylindrical inner portion towards the inner ring and defining with one of the parts of the outer ring a second closed space.

Both closed spaces may contain a lubricant and act as lubricant reservoirs.

Advantageously, each of said separate parts of the outer ring comprises passage means for the lubricant contained in the closed spaces.

Passage means for the lubricant can comprise axial holes at least partly facing one another are made in the thickness of a radial portion of each of the two separate parts of said outer ring, so as to put the two closed spaces into communication

The fixing means can comprise welds or brazing or glue.

### BRIEF DESCRIPTION OF THE DRAWINGS

The present invention will be better understood from studying the detailed description of a number of embodiments considered by way of entirely non-limiting examples and illustrated by the attached drawings in which:

FIG. 1 is an axial half-section of the rolling bearing according to the invention, in a first embodiment;

FIG. 2 is an axial half-section of a second embodiment;

FIG. 3 is an axial half-section of a third embodiment; and

FIG. 4 is an axial half-section of a fourth embodiment.

### DESCRIPTION OF SOME EMBODIMENTS

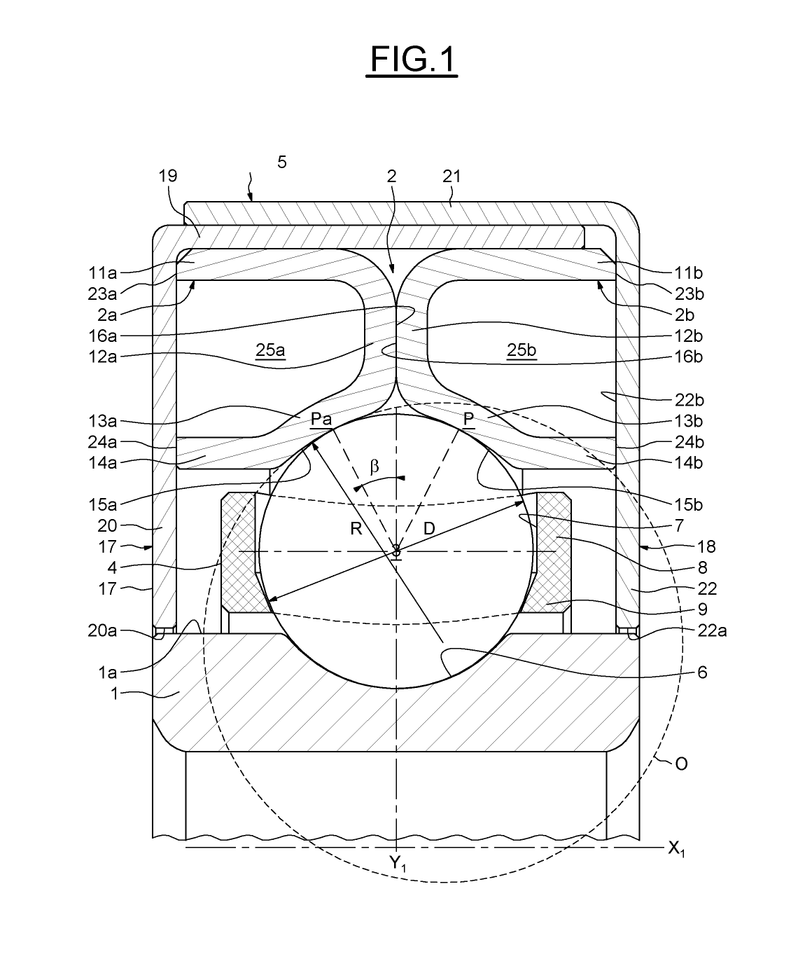

Referring first to FIG. 1, which illustrates an embodiment of a rolling bearing according to the invention; said bearing comprises an inner ring 1, an outer ring 2, a row of rolling elements 3 consisting, in the example illustrated, of balls, held by a cage 4 between the inner ring 1 and the outer ring 2 and an annular housing 5 surrounding the outer ring 2.

The inner ring 1 is solid and has on its outer cylindrical surface 1a, a toroidal groove 6, the radius of curvature of which is slightly greater than the radius of the rolling elements 3 and forms a raceway 15a, 15b for the rolling elements 3. The inner ring 1 may be manufactured by machining or by pressing a steel blank, which is then ground and optionally lapped at the bearing race 6 in order to give the ring 1 its geometrical characteristics and its final surface finish.

The cage 4 comprises a plurality of cavities 7 designed to house the rolling elements 3 and keep them uniformly circumferentially spaced. The cavities 7 are advantageously of spherical shape with a diameter slightly greater than that of the rolling elements 3. The cavities 7 are provided in the radial thickness of the cage 4 having a radial portion 8 radially facing the outer ring 2 and extending radially inwards by a conical portion 9. The conical portion 9 is located radially facing the inner ring 1 and extends axially towards the rolling elements 3. The radial portion 8 and the conical portion 9 define the cavities 7. The conical portion 9 forms a guide portion for the rolling elements 3.

In this embodiment, the outer ring 2 comprises two separate parts 2a, 2b or half rings. The two parts 2a, 2b of the outer ring 2 are identical and symmetric with respect to the axial plane of symmetry of the bearing in order to reduce manufacturing costs. These two outer half-rings 2a, 2b may advantageously be manufactured by cutting and pressing a metal sheet, the components obtained then being hardened by heat treatment. The raceways intended for the rolling elements 3 may be ground and/or lapped in order to give them their definitive geometric characteristics and surface finish. Since the two half-rings 2a, 2b are identical in this example, only one of them, having the reference “a” will be described here, it being understood that the identical elements of the other half-ring 2b bear the reference “b” in the figure.

The half-ring 2a of the outer ring 2 comprises an outer axial portion 11a, a radial portion 12a, a curved portion 13a and an inner axial portion 14a. The radial portion 12a connects to the outer axial portion 11a and to the curved portion 13a. The curved portion 13a defines part of a raceway 15a for the rolling elements 3. The curved portion 13a also connects to the inner axial portion 14a. Each rolling element 3 has a contact point Pa, P with the corresponding half-ring 2a, 2b. The angle β between one contact point Pa, P and the radial symmetry axis Y1 passing through the centre of the balls 3 is comprised between 25° and 45°. In the event of dimensional variations of the half-rings, the contact between the rolling elements 3 and the curved portions 13a, 13b of the corresponding outer half-ring 2a, 2b remains. The two outer half-rings 2a, 2b are arranged with the radial faces 16a, 16b of the radial portions 12a, 12b in axial contact with one another, substantially in the radial symmetry plane of the rolling elements 3.

In this embodiment, the ratio between the radius of curvature R of one raceway 15a, 15b and the diameter D of the rolling elements 3 is higher than 0:55, preferably comprised between 0:55 and 0:71, more preferably higher than 0:71. The radius of curvature R of a raceway is the radius of an imaginary sphere O illustrated on FIG. 1.

The housing 5, which is advantageously made of a stamped metal sheet, comprises two distinct annular parts 17, 18 enclosing the two outer half-rings 2a, 2b so as to hold them firmly together in the axial direction. The parts 17, 18 of the housing 5 may advantageously be produced in an economical way from a single metal sheet by cutting and pressing. Each distinct part 17, 18 have an L-shaped structure.

The first part 17 comprises an inner axial cylindrical portion 19 for retaining radially said outer rings 2a, 2b. The inner axial cylindrical portion 19 surrounds the outer rings 2a, 2b and is in contact with the outer axial portions 11a, 11b of the outer rings 2a, 2b. The first part 17 further comprises a radial flange 20 extending radially from the inner axial cylindrical portion 19 towards the immediate vicinity of the outer cylindrical surface 1a of the inner ring 1, so as to leave a clearance between the inner edge 20a of the radial flange 20 and the cylindrical surface 1a of the inner ring 1.

The second part 18 of the housing 5 comprises an outer axial cylindrical portion 21 surrounding the inner axial cylindrical portion 19 of the first part 17. The second part 18 further comprises a radial flange 22 extending radially from the outer axial cylindrical portion 21 towards the immediate vicinity of the outer cylindrical surface 1a of the inner ring 1, so as to leave a clearance between the inner edge 22a of the radial flange 22 and the cylindrical surface 1a of the inner ring 1.

The half-rings 2a, 2b are centred in the inner axial portion 19 of the part first 17 of the housing 5 by contact between the axial portions 11a, 11b and the bore of the said inner axial portion 19. The outer radial faces 23a, 23b which form the outer edges of the outer axial portions 11a, 11b are respectively in contact with the radial flanges 20, 22 of the parts 17, 18 of the housing 5, thus axially clamping the two half-rings 2a, 2b together. The outer radial faces 24a, 24b which form the outer edges of the inner axial portions 14a, 14b are also in contact with the radial flanges 20, 22.

As an alternative, an axial clearance (not shown) may be provided between the outer edges 24a, 24b of the inner axial portions 14a, 14b and the radial flanges 20, 22 of the housing 5.

Each of the half-rings 2a, 2b defines, with the housing 5, an annular closed space 25a, 25b that acts as a lubricant reservoir, the lubricant contained in these spaces 25a, 25b not being depicted in the figure. More specifically, the closed space 25a is delimited by the outer axial portion 11a, the radial portion 12a, the portion 13a, and the inner axial portion 14a, and, adjacent to these portions, the radial flange 20 of the first part 17 of the housing 5. The lubricant used may be grease or oil.

Lubricant can be packed into the space 25a which constitutes a first lubricant reservoir between the half-ring 2a and the inner ring 1. Lubricant is also packed into the second space 25b and into the volume remaining between the inner 1 and outer 2 rings.

The outer axial cylindrical portion 21 is fixed to the inner axial cylindrical portion 19 by means of welding, brazing or glue.

In this embodiment, the inner radial faces 16a, 16b of the radial portions 12a, 12b are in contact with one another.

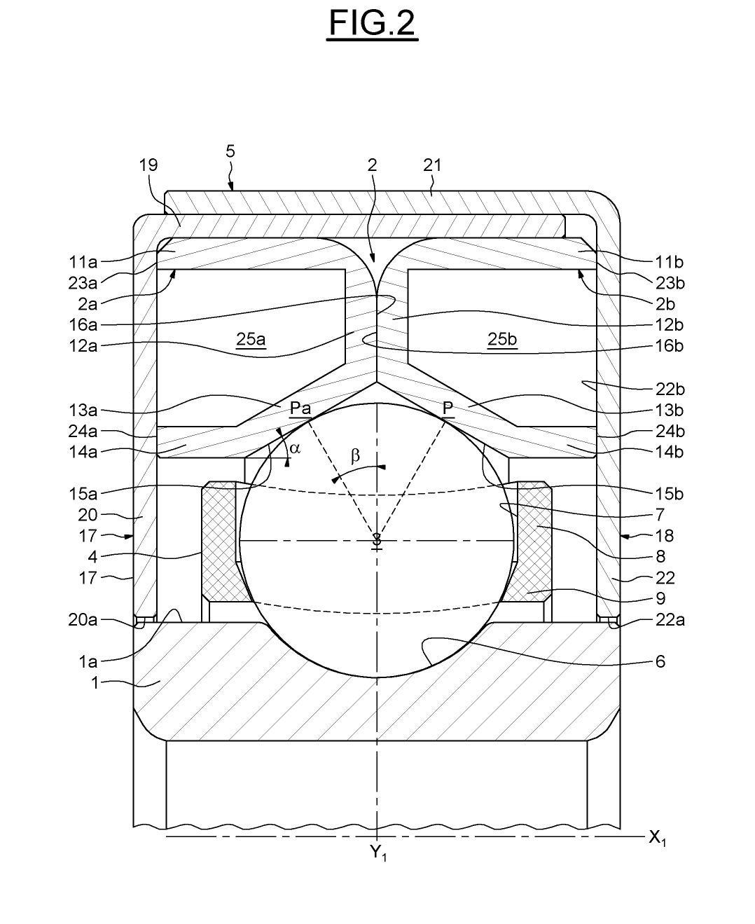

In the embodiment illustrated in FIG. 2, in which similar parts bear the same references, the portions 13a, 13b are flat portions. The ratio between the radius of curvature R of one raceway 15a, 15b and the diameter D of the rolling elements 3 is infinite so as to form a flat raceways 15a, 15b for the rolling elements 3.

The half-ring 2a of the outer ring 2 of this embodiment comprises an outer axial portion 11a, a radial portion 12a, a flat portion 13a and an inner axial portion 14a. The radial portion 12a connects to the outer axial portion 11a and to the flat portion 13a. The flat portion 13a defines part of a flat raceway 15a for the rolling elements 3. The flat portion 13a also connects to the inner axial portion 14a. The angle α between the flat portion 13a and the rotation symmetry axis X1 of the bearing is comprised between 25° and 45°. For example, the angle α may be comprised between 40° and 50°, and more preferably equal to 45°.

Each rolling element 3 has a contact point Pa, P with the corresponding half-ring 2a, 2b. The angle β between the contact point Pa, P and the radial symmetry axis Y1 passing through the centre of the balls 3 is comprised between 25° and 45°. In the event of dimensional variations of the half-rings, the contact between the rolling elements 3 and the flat portions 13a, 13b of the corresponding outer half-ring 2a, 2b remains. The two outer half-rings 2a, 2b are arranged with the radial faces 16a, 16b of the radial portions 12a, 12b in axial contact with one another, substantially in the radial symmetry plane of the rolling elements 3.

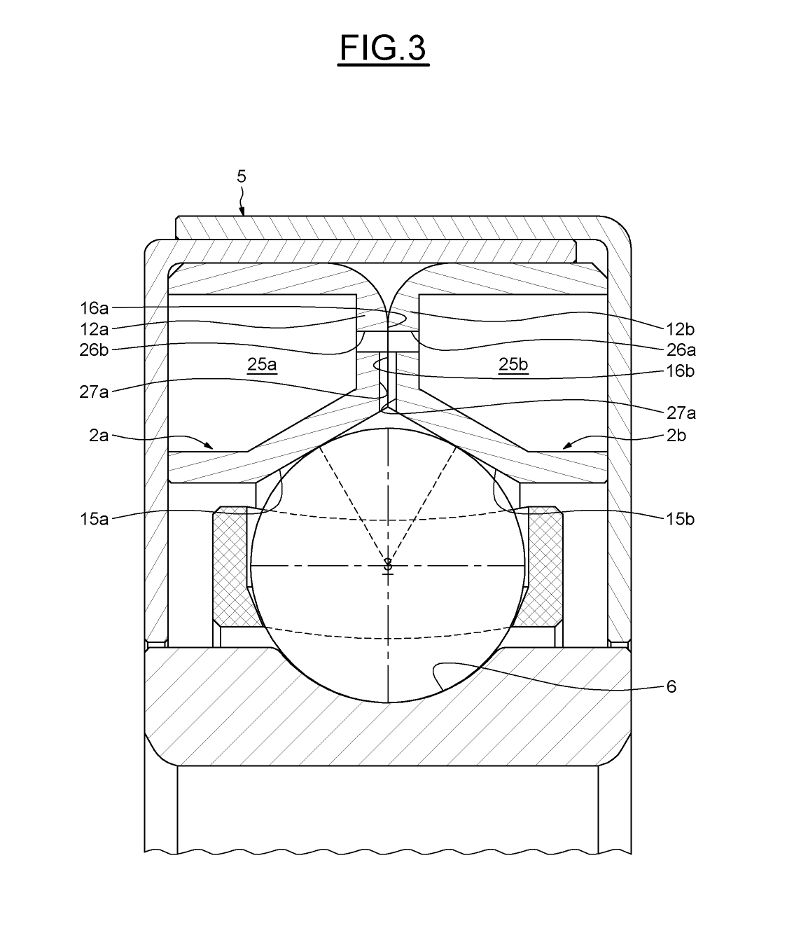

In the embodiment illustrated in FIG. 3, in which similar parts bear the same references, differs from the embodiment of FIG. 2 in that passage means may be provided to allow the lubricant to pass from the closed spaces 25a, 25b, that act as lubricant reservoirs, to the raceways 6 and 15a, 15b.

These passage means comprise a plurality of axial through-holes 26a, 26b provided in the thickness of the radial portions 12a, 12b of the outer half-rings 2a, 2b, at least partially face one another, so as to put the two closed spaces 25a, 25b into communication. Each through-hole 26a, 26b communicates with a radial passage or duct 27a, 27b which consists of a radial groove provided on the inner face 16a, 16b of the corresponding radial portion 12a 12b. The outer end of the radial passage 27a, 27b is in communication with the corresponding through-hole 26a, 26b and its inner end is in communication with the flat raceway 15a, 15b so as to guide the lubricant directly onto the balls 3 at the bearing race 15a, 15b. It should be understood, however, that the holes 26a, 26b which are associated with a radial passage 27a, 27b can easily not be located facing one another. For preference, the internal surfaces of the spaces 25a, 25b that form a lubricant reservoir have an oil-repellent coating which has the effect of preventing lubricant from adhering to the internal walls and thus of encouraging it to be transferred.

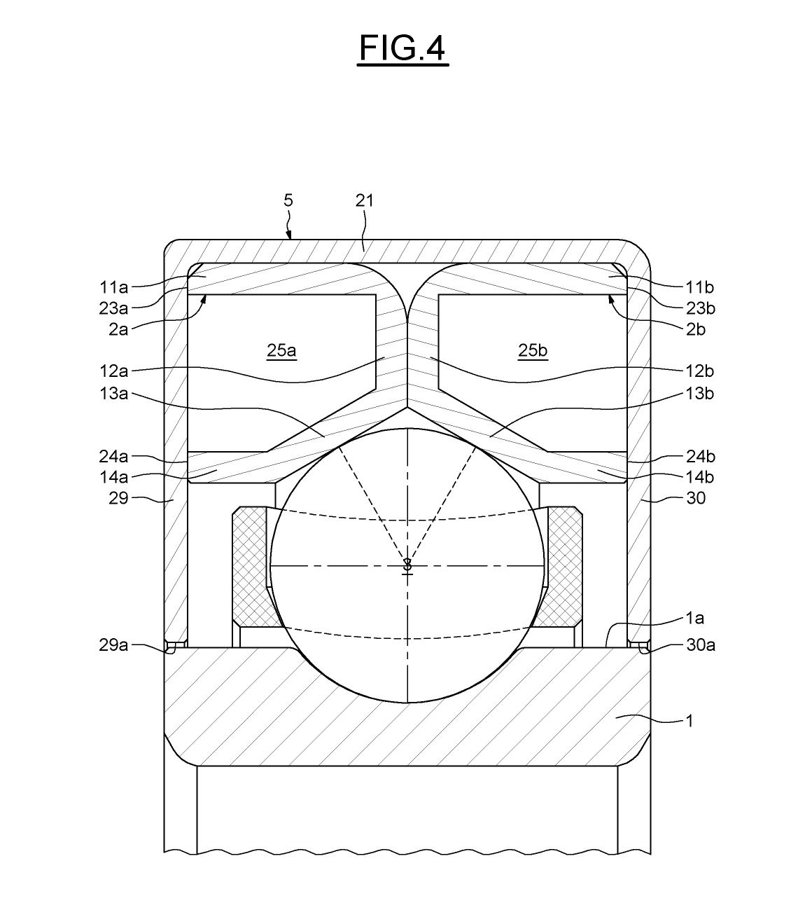

In the embodiment illustrated in FIG. 4, in which similar parts bear the same references, differs from the embodiment of FIG. 2 in that the housing 5 comprises only one part, forming a U-shape. The housing 5, which is advantageously made of a stamped metal sheet, comprises one annular part enclosing the two outer half-rings 2a, 2b so as to hold them firmly together in the axial direction. The housing 5 may advantageously be produced in an economical way from a single metal sheet by cutting and pressing. The housing 5 comprises an inner axial cylindrical portion 28 for retaining radially said outer rings 2a, 2b. The inner axial cylindrical portion 28 surrounds the outer rings 2a, 2b and is in contact with the outer axial portions 11a, 11b of the outer rings 2a, 2b. The housing 5 further comprises two radial flanges 29, 30 extending radially from the inner cylindrical portion 28 towards the immediate vicinity of the outer cylindrical surface 1a of the inner ring 1, so as to leave a clearance between the inner edge 29a, 30a of the corresponding radial flange 29, 30 and the cylindrical surface 1a of the inner ring 1.

The half-rings 2a, 2b are centred in the inner axial cylindrical portion 28 of the housing 5 by contact between the axial portions 11a, 11b and the bore of the said axial inner portion 28. The outer radial faces 23a, 23b which form the outer edges of the outer axial portions 11a, 11b are respectively in contact with the radial flanges 29, 30 of the housing 5, thus axially clamping the two half-rings 2a, 2b together. The outer radial faces 24a, 24b which form the outer edges of the inner axial portions 14a, 14b are also in contact with the radial flanges 29, 30.

Each of the half-rings 2a, 2b defines, with the housing 5, an annular closed space 25a, 25b that acts as a lubricant reservoir, the lubricant contained in these spaces 25a, 25b not being depicted in the figure. More specifically, the closed space 25a is delimited by the outer axial portion 11a, the radial portion 12a, the flat portion 13a, and the inner axial portion 14a, and, adjacent to these portions, the corresponding radial flange 29, 30 of the housing 5. Passage means as described in FIG. 2 can be provided on the embodiment of FIG. 3.

In the embodiment illustrated in the Figures, the outer ring 2 is made up of the two half-rings 2a, 2b and the inner ring 1 is of the solid type. In an alternative form of embodiment, it might be possible to have the outer ring solid while the inner ring would be made up of two half-rings produced by pressing a thin metal sheet in a similar way to the half-rings 2a, 2b of the embodiment of FIGS. 1 and 2. These two half-rings would be mounted inside a housing made in two parts and joined together. In other words, this arrangement would be identical to that of the embodiment illustrated in FIGS. 1 and 2, but with the elements reversed.

In such a case, it would be advantageous for the inner ring made up of the two half-rings functionally to constitute the rotating part of the rolling bearing. This is because in this case, when the rolling bearing rotates, the lubricant contained in the two spaces of the half-rings that act as lubricant reservoirs would be subjected to centrifugal force and would tend to be dissipated through the passages made in the rings towards the raceways of the bearing.

The specific features and characteristics mentioned for each of the embodiments could be applied without major modification to the other embodiments. Moreover, although the present invention has been illustrated using single-row ball bearings, it will be understood that the invention can be applied without major modification to bearings using rolling elements that are not balls and/or that have several rows of rolling elements. Alternatively, the inner ring could be made of two half rings and surrounded by a housing having two distinct parts as described above.

Thanks to raceways having a ratio between the radius of curvature of a raceway and the diameter of the rolling elements as defined, the friction torque between the rolling elements and the raceways is reduced and thus the service life of the rolling bearing is increased. Furthermore, the contact point between the rolling elements and the raceways is maintained in any circumstances, so that a possible radial offset of the two outer raceways will not have an impact on the friction torque of the bearing. Indeed, in case of geometric variations between the two outer raceways, the portions forming the outer raceways of the rolling bearing absorb these variations and do not have any influence on the friction torque.

1. A rolling bearing comprising an inner ring, an outer ring, at least one row of rolling elements between a pair of raceways, each raceway of the pair of raceways provided on the inner ring and outer ring, respectively, and an annular housing comprising at least one part surrounding at least one of the inner ring and the outer ring, the outer ring comprising two separate parts, each of the two parts of the outer ring defining one closed space with the housing, wherein the ratio between the radius of curvature of one raceway and the diameter of the rolling elements is higher than 0:55.

2. The rolling bearing according to claim 1, wherein the ratio is comprised between 0:55 and 0:71.

3. The rolling bearing according to claim 1, wherein the ratio is higher than 0:71.

4. The rolling bearing according to claim 3, wherein each part of the outer ring comprises a flat portion contacting the rolling elements so as to form a the raceway for the rolling elements.

5. The rolling bearing according to claim 4, wherein the angle formed between the flat portion and the a rotation symmetry axis of the bearing is between 25° and 45°.

6. The rolling bearing according to claim 5, wherein the angle is equal to 45°.

7. The rolling bearing according to claim 1, wherein each part of the outer ring comprises an outer axial cylindrical portion, a radial portion and an inner axial cylindrical portion, the flat portion being connected to the radial portion and the inner axial cylindrical portion.

8. The rolling bearing according to claim 1, wherein the parts of the outer ring are manufactured by cutting and pressing a metal sheet.

9. The rolling bearing according to claim 1, wherein the housing comprises two distinct parts for retaining the parts of the outer ring and a fixing feature for fixing the distinct parts together, the first part of the housing comprising an inner axial cylindrical portion for retaining radially the outer ring and the second part of the housing comprising an outer axial cylindrical portion surrounding the inner axial cylindrical portion.

10. The rolling bearing according to claim 9 wherein the first part of the housing comprises a radial flange extending radially from the inner cylindrical portion towards the inner ring and defining with one of the parts of the outer ring, a first closed space.

11. The rolling bearing according to claim 9, wherein the second part of the housing comprises a radial flange extending radially from the outer axial cylindrical portion towards the inner ring and defining with one of the parts of the outer ring, a second closed space.

12. The rolling bearing according to claims 9, wherein both closed spaces contain a lubricant and act as lubricant reservoirs.

13. The rolling bearing according to claim 12, wherein each of the separate parts of the outer ring comprises a passage feature for the lubricant contained in the closed spaces.

14. The rolling bearing according to claim 13, wherein the passage feature for the lubricant comprising axial holes at least partly facing one another are made in the thickness of a radial portion of each of the two separate parts of the outer ring, so as to put the two closed spaces into communication with one another.

15. The rolling bearing according to claim 9, wherein the fixing feature comprises one of welds, brazing, or glue.
